(19) United States
(12) Patent Application Publication
(10) Pub. No.: US 2006/0085556 A1
(43) Pub. Date: Apr. 20, 2006

(54) Method and apparatus for accessing CDMA2000 networks

(76) Inventors: Chueng-Hsien Lin, Cranbury, NJ (US); Sarit Mukherjee, Morganville, NJ (US); Sanjoy Paul, Morganville, NJ (US)

Correspondence Address: PATTERSON & SHERIDAN, LLP/;LUCENT TECHNOLOGIES, INC, 595 SHREWSBURY AVENUE, SHREWSBURY, NJ, 07702, US

(21) Appl. No.: 10/955,320

(22) Filed: Sep. 30, 2004

(51) Int. Cl. G06F 15/173

(52) U.S. Cl. 709/238

(57) ABSTRACT

A method and apparatus for accessing a CDMA2000 network translate Internet (IP) addresses of wired and wireless out-of-network users in a source IP address of a single CDMA2000 account that is used for data communications with users of the CDMA2000 network by a group of the out-of-network users.

### FIELD OF THE INVENTION

The invention relates to the field of communication networks and, in particular, to CDMA2000 communication networks.

### BACKGROUND OF THE INVENTION

A CDMA2000 standard is a communication standard that allows mobile users (e.g., wireless phones, wireless computers, wireless personal digital assistants (PDAs), and the like) to access Internet-based high-speed voice and data traffic over a cellular network using the Code-Division Multiple Access (CDMA) technology.

A CDMA2000 network provides support for packet data services for the mobile users having valid CDMA2000 accounts. One of the challenging tasks in the field of communications is facilitation of bi-directional data interfaces between users of different wired and wireless communication networks. Establishing data communications between such networks and the CDMA2000 network presents a particular challenge in this regard.

Therefore, there is a need in the art for a method and apparatus for accessing the CDMA2000 network by the out-of-network users.

### SUMMARY OF THE INVENTION

The present invention comprises a method and apparatus for accessing a CDMA2000 network for data communication by out-of-network users.

In a first aspect of the invention, there is provided a method for accessing a CDMA2000 network by the out-of-network users through a single CDMA2000 account. In one exemplary embodiment, the method includes acquiring a single network account (i.e., source Internet (IP) address) for accessing the network, acquiring and storing user IP addresses of the out-of-network users, replacing the user IP addresses in data packets with the source IP address, and accessing the network using the source IP address. In operation, user data packets are transmitted from and received to the source IP address. To forward the reply data packets to the out-of-network user, the source IP address is replaced with the stored user IP address.

In a second aspect of the invention, there is provided an apparatus for accessing a CDMA2000 network by the out-of-network users through a single CDMA2000 account. In one embodiment, the apparatus includes a Network Address Translation/Packet Control Function (NAT-PCF) module coupled to the out-of-network users. The NAT-PCF module accesses the CDMA2000 network by communicating with a Packet Data Serving Node (PDSN) coupled to the Internet. In another embodiment, the apparatus further includes a Wi-Fi Access Point coupled to the mobile out-of-network users and the NAT-PCF module. In operation, these apparatuses execute the inventive method.

### BRIEF DESCRIPTION OF THE DRAWINGS

The teachings of the present invention can be readily understood by considering the following detailed description in conjunction with the accompanying drawings, in which:

FIG. 1 depicts a schematic diagram of a system for accessing a CDMA2000 network by a group of wired users in accordance with one embodiment of the present invention;

FIG. 2 depicts a schematic diagram of a system for accessing a CDMA2000 network by a group of mobile users in accordance with another embodiment of the present invention; and

FIG. 3 depicts a flow diagram of a method for accessing a CDMA2000 network using the apparatuses of FIGS. 1 and 2 in accordance with yet another embodiment of the present invention.

To facilitate understanding, identical reference numerals have been used, where possible, to designate identical elements that are common to the figures.

It is to be noted, however, that the appended drawings illustrate only exemplary embodiments of this invention and are therefore not to be considered limiting of its scope, for the invention may admit to other equally effective embodiments.

### DETAILED DESCRIPTION OF THE INVENTION

The present invention advantageously facilitates accessing a CDMA2000 network by a group of wired or mobile users using a single CDMA2000 account. Herein, the term “CDMA2000 network” (also known as “1xRTT”, “IMT-CDMA Multi-Carrier”, or “IS-95”) refers to the communication networks that are compliant with a Code-Division Multiple Access (CDMA) version of the IMT-2000 standard developed by the International Telecommunication Union (ITU) for third-generation (3G) wireless technology. CDMA2000 networks support mobile (i.e., wireless) voice and data communications at transmission speeds ranging from 144 Kbbs to 2 Mbbs.

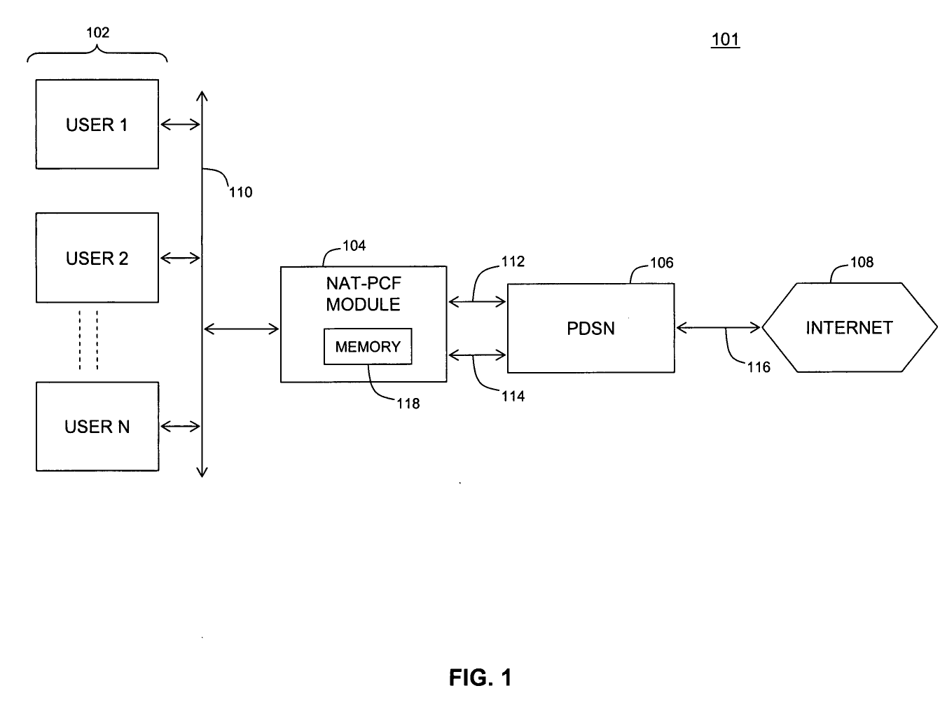

FIG. 1 depicts a schematic diagram of a portion 101 of the CDMA2000 network comprising a NAT-PCF module 104 for accessing a CDMA2000 network by a group of out-of-network wired users 102 in accordance with one embodiment of the present invention. The NAT-PCF 104 module provides for the users 102 (e.g., computers) point-to-point connection to Packet Data Serving Node (PDSN) 106 of the CDMA2000 network. In operation, the PDSN 106 serves as a router to the Internet 108 for CDMA2000 network via an Internet Protocol (IP) based bi-directional connection 116. The NAT-PCF module 104 and the PDSN 106 are interconnected using wired bi-directional interfaces 112 (e.g., data interface A10) and 114 (e.g., signaling interface A1) for packet data services. The data interface 112 is a data tunnel compliant with the IP Generic Routing Encapsulation (GRE) protocol.

Each of the N users 102 has an individual Internet (IP) address. Herein, N is an integer (N≧1) and the individual IP address is referred to as a “user IP address”. The users 102 are not assigned the CDMA2000 accounts and, as such, do not have direct connectivity to the CDMA2000 network. In the depicted embodiment, the NAT-PCF module 104 and the users 102 are coupled to a wired local area network (LAN) 110. In an alternate embodiment (not shown), the users 102 may directly be coupled to the NAT-PCF module 104.

The NAT-PCF module 104 is assigned a valid CDMA2000 account. Upon verification of the account authenticity (e.g., using the PDSN 106) and coupling to the CDMA2000 network, the NAT-PCF module 104 is provided with a single IP address for accessing the CDMA2000 network. Herein, such an address is interchangeably referred to as a “source IP address” or a “Point-to-Point Protocol single IP address” (PPP-SIP).

In the CDMA2000 network, data communications are provided, using the IP Protocol, in a form of data packets. The PPP-SIP is used as a source address for all data packets transmitted from the users 102 to users of the CDMA2000 network. When the PDSN 106 uses the International Mobile Subscriber Identifier (IMSI) for authentication, the NAT-PCF module 104 is additionally assigned a unique IMSI identification number (IN).

To access the CDMA2000 network, the NAT-PCF module 104 emulates the Packet Control Function (PCF) of the network and uses the A11 signaling interface 114 to establish the A10 GRE data tunnel 112 to the PDSN 106. Once the data tunnel 112 has been established, the NAT-PCF module 104 initiates the Point-to-Point Protocol (PPP) to establish a PPP link with the PDSN 106. The PPP link provides the users 102 with connectivity to the Internet-based CDMA2000 network.

In operation, the out-of-network users 102 send data packets to the NAT-PCF module 104 for delivery to correspondents on the CDMA2000 network and receive, via the module 104, reply data packets from the correspondents. The NAT-PCF module 104 replaces a user IP address in each data packet originated by a user 102 with the source IP address (i.e., PPP-SIP) and stores the user IP address and a destination CDMA2000 address in an internal memory 118. The module 104 transmits the modified data packets to the PDSN 106 for delivery to the correspondents on the CDMA2000 network. When the reply data packets from the correspondents arrive at the PPP-SIP, the NAT-PCF module 104 retrieves the user IP address from the memory 118, replaces the destination IP address (i.e., the PPP-SIP) in the reply data packets with the retrieved user IP address, and forwards the modified data packets to the corresponding user 102. When the data packets carry Transmission Control Protocol (TCP), the NAT-PCF module also replaces the source port number for each TCP packet before sending the packet to the PDSN 106 and restores the original source port number before forwarding replies to the users 102.

The module 104 performs functions of the default router for the users 102. In one exemplary embodiment, the module 104 has a built-in Dynamic Host Configuration Protocol (DHCP) server for assigning IP configuration information (e.g., IP address, network mask, and Domain Name Server (DNS) IP addresses) to the users 102.

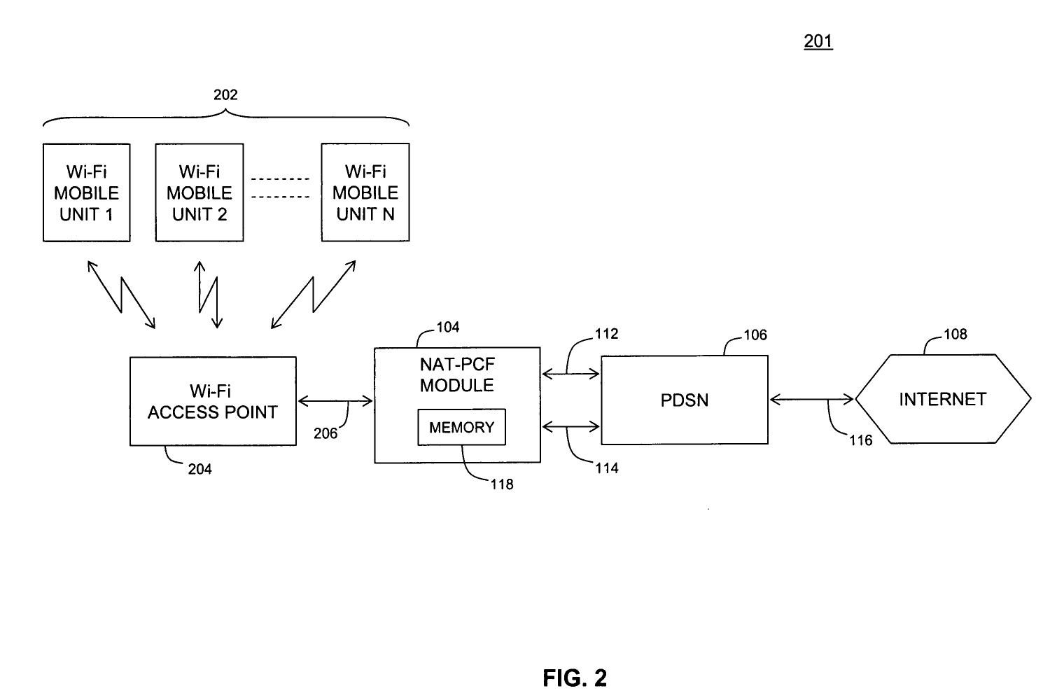

FIG. 2 depicts a schematic diagram of a portion 201 of the CDMA2000 network comprising a Wi-Fi Access Point and the NAT-PCF module for accessing a CDMA2000 network by a group of out-of-network mobile users in accordance with another embodiment of the present invention. In this embodiment, the users 202 (e.g., Wi-Fi (wireless fidelity) mobile users) are coupled to the NAT-PCF module 104 using the Wi-Fi Access Point 204. The Wi-Fi Access Point 204 is coupled to the NAT-PCF module 104 using a wired interface 206 and performs as a bridging device between the module 104 and a wireless LAN composed of the Wi-Fi mobile users 202.

Like in the embodiment of FIG. 1, the NAT-PCF module 104 performs functions of the default router for the Wi-Fi mobile users 202. Additionally, the NAT-PCF module 104 can include a DHCP server for providing the IP configuration information to the Wi-Fi mobile users 202.

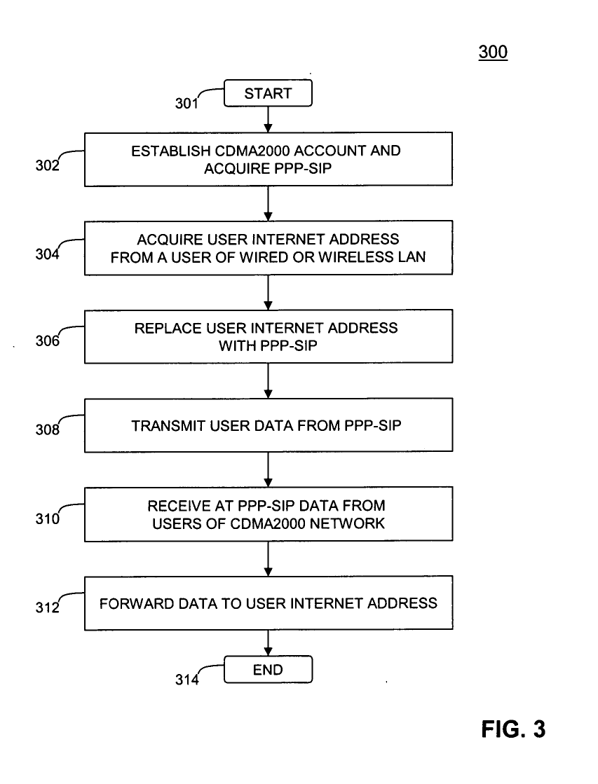

FIG. 3 depicts a flow diagram of one embodiment of the inventive method for accessing a CDMA2000 network using the apparatuses of FIGS. 1-2 as a process 300. For best understanding of this embodiment of the invention, the reader should refer simultaneously to FIGS. 1-3.

The process 300 starts at step 301 and proceeds to step 302. At step 302, the NAT-PCF module 104 acquires a valid CDMA2000 account information from the memory 118 and then initiates the A11 signaling interface 114 to establish the A10 GRE data tunnel interface 112 with the PDSN 106. Once the A10 data tunnel 112 is established, the NAT-PCF module 104 initiates the PPP protocol and provides account information to the PDSN 106 for authentication. The NAT-PCF module 104 obtains the PPP-SIP address from the PDSN 106 after successful account authentication. Optionally, the module 104 may also be assigned an IMSI ID number.

At step 304, the NAT-PCF module 104 acquires a user IP from one of users 102 of wired LAN 110 (FIG. 1) or one of mobile users 202 (FIG. 2) requesting a data communication link (i.e., sending data packets) to the user(s) of the CDMA2000 network.

At step 306, the NAT-PCF module 104 replaces the user IP address with the PPP-SIP (i.e., source IP address) before transmitting data packets from the out-of-network user (i.e., user 102 or user 202) to the PDSN 106 for delivery to the user(s) of the CDMA2000 network. The user IP address and the destination address of the sent data packets are saved in the memory 118 of the NAT-PCF module 104. For TCP data packets, the source port number of TCP is also saved in the memory 108.

At step 308, the PDSN 106 delivers the modified IP data packets from the NAT-PCF module 104 to the CDMA2000 network. The sent data packets from the users 102 or users 202 contain the PPP-SIP as an address of origin (i.e., address of a sending user).

At step 310, reply data packets that are sent by the user of CDMA2000 network to the user 102 or user 202 are delivered to the PPP-SIP (i.e., to the NAT-PCF module 104). The module 104 retrieves from the memory 118 the user IP address of the corresponding user 102 or user 202 that, at step 304, requested the data communication. Then, the module 104 replaces the PPP-SIP in the received reply data packets with the user IP address of that out-of-network user.

At step 312, the NAT-PCF module 104 forwards the modified reply data packet to the user 102 or user 202. At step 314, the process 300 ends.

In operation, upon completion of step 302, execution of steps 304, 306, 308, 310, and 312 relating to data communications of multiple users 102 or 202 with users of the CDMA2000 network may be superimposed to provide, in real time, substantially simultaneous bi-directional data links between several out-of-network users and the users of the CDMA2000 network.

The invention is described above as using specific functions and devices. It will be appreciated by those skilled in the art that a large number of functions and devices that may alternatively be employed, either individually or in combination, to achieve the objects of the invention described herein are within the scope of the invention.

While the forgoing is directed to various embodiments of the present invention, other and further embodiments of the invention may be devised without departing from the basic scope thereof. As such, the appropriate scope of the invention is to be determined according to the claims, which follow.

What is claimed is:

1. A method for accessing a network for data communications by out-of-network users having Internet addresses, comprising:
(a) acquiring a source Internet address for accessing the network;
(b) acquiring a user Internet address from at least one out-of-network user;
(c) acquiring data packets from at least one out-of-network user;
(d) replacing the user Internet address in the data packets with the source Internet address; and
(e) accessing the network using the source Internet address.

2. The method of claim 1 wherein the at least one out-of-network user is a computer coupled to a wired local area network or a stand-alone computer.

3. The method of claim 1 wherein the at least one out-of-network user is a user of a wireless network.

4. The method of claim 1 wherein the step (a) further comprises:
acquiring the source Internet address using a Network Address Translation/Packet Control Function (NAT-PCF) module.

5. The method of claim 1 wherein the step (b) further comprises:
coupling the at least one out-of-network user using a Wi-Fi Access Point of the network.

6. The method of claim 1 wherein the step (d) further comprises:
storing a user Internet address of the at least one out-of-network user;
storing a network destination address of the data packets; and
assigning the source Internet address to the data packets.

7. The method of claim 1 wherein the step (e) further comprises:
transmitting the data packets from the source Internet address.

8. The method of claim 1 wherein the step (e) further comprises:
receiving at the source Internet address reply data packets directed to the at least one out-of-network one user;
retrieving user Internet address of the at least one out-of-network user;
replacing the source Internet address with the user Internet address; and
forwarding the reply data packets to the at least one out-of-network user.

9. The method of claim 8 further comprising:
defining the user Internet address using a correlation between an address of origin in the reply data packets and a network destination address in the data packets sent by the at least one out-of-network user.

10. The method of claim 1 wherein the network is a CDMA2000 network.

11. An apparatus for accessing a network for data communications by out-of-network users having Internet addresses, comprising:
a Network Address Translation/Packet Control Function (NAT-PCF) module coupled to a Packet Data Serving Node (PDSN) of the network.

12. The apparatus of claim 11 wherein the NAT-PCF module is further coupled to a wired interface to at least one computer or a local area network.

13. The apparatus of claim 11 wherein the NAT-PCF module is further coupled to a Wi-Fi Access Point of a wireless network.

14. The apparatus of claim 13 wherein the Wi-Fi Access Point is further coupled to at least one user of the wireless network.

15. The apparatus of claim 11 wherein the NAT-PCF module comprises:
a means for acquiring a source Internet address for accessing the network;
a means for acquiring and storing a user Internet address from at least one out-of-network user;
a means for storing network destination addresses of data packets received from the at least one out-of-network user;
a means for replacing a TCP source port number;
a means for replacing the user Internet address;
a means for replacing the source Internet address; and
a means for accessing the network using the source Internet address.

16. The apparatus of claim 15 wherein the means for replacing the user Internet address assign the source Internet address to the data packets received from the at least one out-of-network user.

17. The apparatus of claim 15 wherein the means for replacing the source Internet address assign the user Internet address to reply data packets received from the network for the at least one out-of-network user.

18. The apparatus of claim 15 wherein the means for accessing the network transmit the data packets to users of the network from the source Internet address.

19. The apparatus of claim 15 wherein the means for accessing the network receive reply data packets from users of the network at the source Internet address.

20. The apparatus of claim 15 wherein the means for accessing the network forward the reply data packets to the directed at least one out-of-network user.

21. The apparatus of claim 11 wherein the NAT-PCF module further includes atleast one of a default router, a Dynamic Host Configuration Protocol (DHCP) server, a Domain Name System (DNS) server, and a Remote Authentication Dial in User Service (RADIUS) server.

22. The apparatus of claim 11 wherein the network is a CDMA2000 network.
